(19) United States
(12) Patent Application Publication
(10) Pub. No.: US 2024/0363276 A1
(43) Pub. Date: Oct. 31, 2024

(54) INDUCTOR COMPONENT

(71) Applicant: Murata Manufacturing Co., Ltd., Kyoto-fu (JP)

(72) Inventor: Shoto KAWAMURA, Nagaokakyo-shi (JP)

(73) Assignee: Murata Manufacturing Co., Ltd., Kyoto-fu (JP)

(21) Appl. No.: 18/644,797

(22) Filed: Apr. 24, 2024

(30) Foreign Application Priority Data
Apr. 26, 2023 (JP) 2023-072424

(51) Int. Cl. H01F 17/00; H01F 27/29

(52) U.S. Cl. CPC H01F 17/0013; H01F 27/292; H01F 2017/002

(57) ABSTRACT

An inductor component includes a body, a coil in the body and helically wound about an axis, and first and second outer electrodes at the body and electrically connected to the coil. The body has first and second end surfaces opposite to each other, first and second side surfaces opposite to each other, a bottom surface and a top surface opposite to the bottom surface. The first and second outer electrodes are at least on the bottom surface. The axis is parallel to the bottom surface and crosses the first and second side surfaces. The coil includes a wound portion helically wound about the axis. When viewed in a direction of the axis, a first shortest distance between an outer peripheral surface of the wound portion and the first outer electrode is greater than a second shortest distance between the outer peripheral surface and the top surface.

### CROSS-REFERENCE TO RELATED APPLICATION

This application claims benefit of priority to Japanese Patent Application No. 2023-072424, filed Apr. 26, 2023, the entire content of which is incorporated herein by reference.

### BACKGROUND

### Technical Field

The present disclosure relates to an inductor component.

### Background Art

An example of an existing inductor component is described in Japanese Unexamined Patent Application Publication No. 2017-216428. Japanese Unexamined Patent Application Publication No. 2017-216428 describes that this inductor component includes an insulator portion, and a coil portion disposed inside the insulator portion and including a surrounding portion wound about an axial direction, and has a small size and high performance.

### SUMMARY

In such an inductor component as the above existing inductor component, the distance between first and second outer electrodes and a coil is short. Thus, during firing, a high internal stress occurs between the first and second outer electrodes and the coil, and a body may have structural defects such as cracks, fracture, or deformation.

Accordingly, the present disclosure provides an inductor component that reduces internal stress caused in a coil during firing.

To address the above issue, an inductor component according to an aspect of the present disclosure includes a body, a coil disposed in the body and helically wound about an axis, and a first outer electrode and a second outer electrode disposed at the body and electrically connected to the coil. The body has a first end surface and a second end surface opposite to each other, a first side surface and a second side surface opposite to each other, a bottom surface that connects the first end surface and the second end surface to each other and connects the first side surface and the second side surface to each other, and a top surface opposite to the bottom surface. The first outer electrode and the second outer electrode are disposed at least on the bottom surface. The axis is parallel to the bottom surface and crosses the first side surface and the second side surface. The coil includes a wound portion helically wound about the axis. Also, when viewed in a direction of the axis, a first shortest distance between an outer peripheral surface of the wound portion and the first outer electrode is greater than a second shortest distance between the outer peripheral surface and the top surface.

The first shortest distance being greater than the second shortest distance indicates that the first outer electrode and the coil are spaced a distance apart from each other. When the first outer electrode and the coil are spaced a distance apart from each other, an internal stress that occurs between the first outer electrode and the coil during firing is reduced. This structure can thus reduce occurrences of structural defects such as detachment in a coil wiring layer or a via wiring layer.

An inductor component according to an aspect of the present disclosure can reduce an internal stress that occurs in a coil during firing.

### BRIEF DESCRIPTION OF THE DRAWINGS

FIG. 1 is a perspective view of an inductor component according to a first embodiment;

FIG. 2 is a perspective front view of an inductor component viewed from a first side surface;

FIG. 3 is an exploded plan view of an inductor component;

FIG. 4 is a perspective front view of an inductor component according to a second embodiment, when viewed in a direction from a first side surface of the inductor component;

FIG. 5A is an exploded plan view of an inductor component;

FIG. 5B is an exploded plan view of an inductor component; and

FIG. 5C is an exploded plan view of an inductor component.

### DETAILED DESCRIPTION

An inductor component according to an aspect of the present disclosure is described in further detail below with illustrated embodiments. Some of the drawings are schematic, and may fail to reflect the actual dimensions or ratios.

First Embodiment

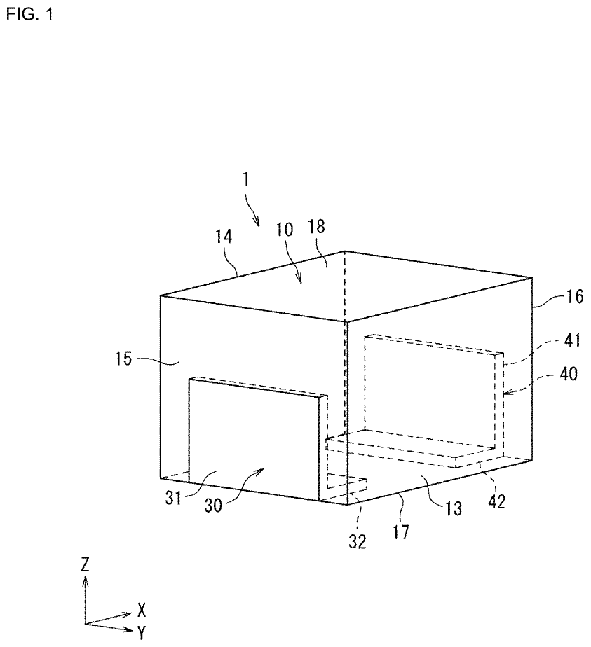

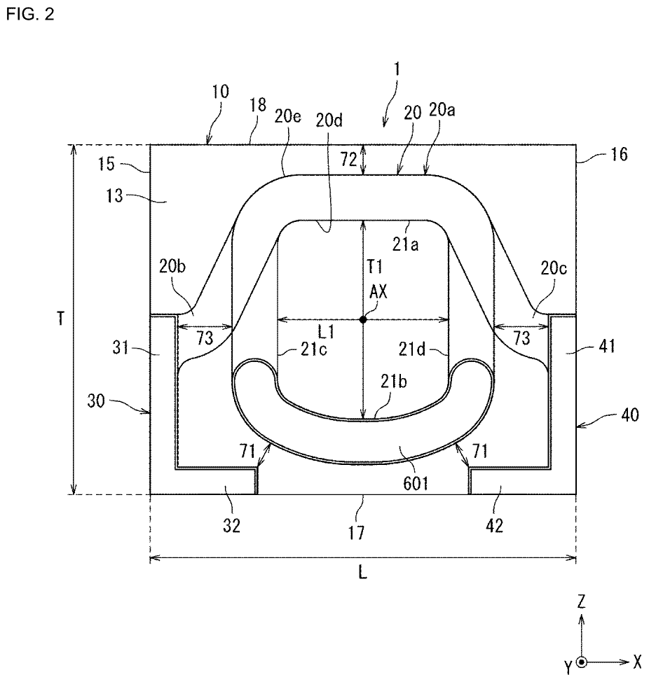

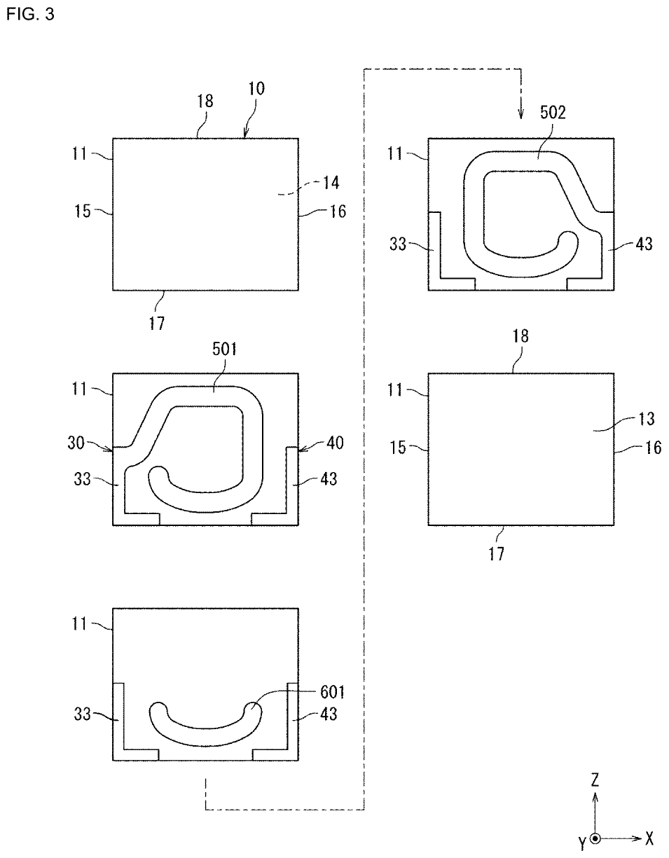

FIG. 1 is a perspective view of an inductor component according to a first embodiment. FIG. 2 is a perspective front view of an inductor component when viewed in a direction from a first side surface. FIG. 3 is an exploded plan view of an inductor component. As illustrated in FIG. 1, FIG. 2, and FIG. 3, an inductor component 1 includes a body 10, a coil 20 disposed in the body 10 and helically wound about an axis AX, and a first outer electrode 30 and a second outer electrode 40 disposed on the body 10 and electrically connected to the coil 20. For convenience, or for ease of understanding the structure, FIG. 2 illustrates the body and the coil as being transparent, but they may be semitransparent or opaque.

The inductor component 1 is electrically connected to a wire of a circuit board not illustrated with the first and second outer electrodes 30 and 40. The inductor component 1 is, for example, used as an impedance matching coil (or matching coil) for a high-frequency circuit, and included in an electronic device, such as a personal computer, a digital video disk (DVD) player, a digital camera, a television set, a mobile phone, automotive electronics, or a medical/industrial machine. The purpose of use of the inductor component 1 is not limited to this, and the inductor component 1 is also usable in, for example, a tuning circuit, a filter circuit, or a rectification smoothing circuit.

The body 10 has a substantially rectangular prism shape. The body 10 has a first end surface 15 and a second end surface 16 opposite to each other, a first side surface 13 and a second side surface 14 opposite to each other, a bottom surface 17 that connects the first end surface 15 and the second end surface 16 to each other and connects the first side surface 13 and the second side surface 14 to each other, and a top surface 18 opposite to the bottom surface 17. When the inductor component 1 is mounted on a mount board not illustrated, the bottom surface 17 faces the mount board.

As illustrated, an X direction is a direction perpendicular to the first end surface 15 and the second end surface 16, directing from the first end surface 15 to the second end surface 16. A Y direction is a direction perpendicular to the first side surface 13 and the second side surface 14, directing from the second side surface 14 to the first side surface 13. A Z direction is a direction perpendicular to the bottom surface 17 and the top surface 18, directing from the bottom surface 17 to the top surface 18. The X direction is also referred to as a length direction of the body 10, the Y direction is also referred to as a width direction of the body 10, and the Z direction is also referred to as a height direction of the body 10. The X direction, the Y direction, and the Z direction are perpendicular to each other, and form a left-hand system when arranged in order of X, Y, and Z.

The X direction is also referred to as a length direction of the body 10, the Y direction is also referred to as a width direction of the body 10, and the Z direction is also referred to as a height direction of the body 10. The length direction is a direction in which the first end surface 15 and the second end surface 16 are opposite to each other, and parallel to the straight line connecting the first end surface 15 and the second end surface 16 to each other at a shortest distance. The width direction is a direction in which the first side surface 13 and the second side surface 14 are opposite to each other, and parallel to the straight line connecting the first side surface 13 and the second side surface 14 to each other at a shortest distance. The height direction is a direction in which the top surface 18 and the bottom surface 17 are opposite to each other, and parallel to the straight line connecting the top surface 18 and the bottom surface 17 to each other at a shortest distance.

The body 10 is formed by laminating multiple insulating layers 11. The insulating layers 11 are formed from a material such as a material containing borosilicate glass as a main component, ferrite, or resin. The insulating layers 11 are laminated in the direction parallel to the first and second end surfaces 15 and 16 and the bottom surface 17 of the body 10 (laminated in the Y direction). Specifically, the insulating layers 11 are layers expanding in the XZ plane. Herein, “parallel” is not limited to a parallel relationship in a strict sense, and includes a substantially parallel relationship in consideration of the range of actual variations. In the body 10, the interfaces between the multiple insulating layers 11 may be unclear due to, for example, firing. In FIG. 3, the direction from the upper left to the lower right is defined as a lamination direction (Y direction).

The first outer electrode 30 and the second outer electrode 40 are formed from an electroconductive material such as Ag, Cu, Au, or an alloy containing any of these as a main component. The first outer electrode 30 and the second outer electrode 40 may have surfaces exposed from the body 10 coated with, for example, Ni or Sn plating.

The first outer electrode 30 has an L shape extending from the first end surface 15 to the bottom surface 17. The first outer electrode 30 is embedded in the body 10 while being exposed from the first end surface 15 and the bottom surface 17. The first outer electrode 30 includes a first end surface portion 31 extending along the first end surface 15, and a first bottom surface portion 32 connected to the first end surface portion 31 and extending along the bottom surface 17.

The second outer electrode 40 has an L shape extending from the second end surface 16 to the bottom surface 17. The second outer electrode 40 is embedded in the body 10 while being exposed from the second end surface 16 and the bottom surface 17. The second outer electrode 40 includes a second end surface portion 41 extending along the second end surface 16, and a second bottom surface portion 42 connected to the second end surface portion 41 and extending along the bottom surface 17.

The first outer electrode 30 has a structure including multiple laminated first outer electrode conductor layers 33 embedded in the body 10 (insulating layers 11). The second outer electrode 40 has a structure including multiple second outer electrode conductor layers 43 embedded in the body 10 (insulating layers 11). The first outer electrode conductor layers 33 extend along the first end surface 15 and the bottom surface 17, and the second outer electrode conductor layers 43 extend along the second end surface 16 and the bottom surface 17.

The first and second outer electrodes 30 and 40 can thus be embedded in the body 10. The inductor component with this structure can have a smaller size than an inductor component with a structure where outer electrodes are externally attached to the body 10. In addition, the coil 20 and the outer electrodes 30 and 40 can be formed in the same process. The positional relationship between the coil 20 and the first and second outer electrodes 30 and 40 thus has fewer variations, and the inductor component 1 can have electric characteristics with fewer variations.

The first outer electrode 30 may be formed from the first bottom surface portion 32 without including the first end surface portion 31. Similarly, the second outer electrode 40 may be formed from the second bottom surface portion 42 without including the second end surface portion 41. More specifically, the first outer electrode 30 and the second outer electrode 40 may be disposed on at least the bottom surface 17 of the body 10.

The coil 20 is formed from, for example, the same electroconductive material as the first and second outer electrodes 30 and 40. The coil 20 is helically wound about the direction in which the insulating layers 11 are laminated. The first end of the coil 20 is connected to the first outer electrode 30, and the second end of the coil 20 is connected to the second outer electrode 40. In the present embodiment, the coil 20 and the first and second outer electrodes 30 and 40 are integrated without clear boundaries. Instead, the coil and the outer electrodes may be formed from different materials or by different methods to have boundaries therebetween.

The coil 20 is wound about the axis AX that is parallel to the bottom surface 17, and that crosses the first side surface 13 and the second side surface 14. The axis AX of the coil 20 meets the direction in which the insulating layers 11 are laminated (the Y direction). In other words, the multiple insulating layers 11 are laminated along the axis AX. The axis AX of the coil 20 indicates the center axis of the helical shape of the coil 20. More specifically, the axis AX indicates the center of the innermost circumference of the coil 20.

The coil 20 includes a wound portion 20a, a first extended portion 20b that connects the first end of the wound portion 20a and the first outer electrode 30 to each other, and a second extended portion 20c that connects the second end of the wound portion 20a and the second outer electrode 40 to each other. In the present embodiment, the wound portion 20a and the first and second extended portions 20b and 20c are integrated without clear boundaries. Instead, the wound portion and the extended portions may be formed from different materials or by different methods to have boundaries therebetween.

The wound portion 20a is helically wound about the axis AX. More specifically, the wound portion 20a indicates a helically wound portion where the portions of the coil 20 overlap when viewed in the direction parallel to the axis AX. The first and second extended portions 20b and 20c are portions deviating from the overlapping portions.

When viewed in the direction of the axis AX of the coil 20, the coil 20 has a shape of bilateral symmetry with respect to the straight line crossing the axis AX of the coil 20 and parallel to the Z direction. The inductor component 1 with this structure thus has fewer characteristic variations.

As illustrated in FIG. 3, the coil 20 includes two coil wiring layers, or first and second coil wiring layers 501 and 502 laminated along the axis AX, and a first via wiring layer 601 located between the first and second coil wiring layers 501 and 502 adjacent in the direction of the axis AX and connecting the first and second coil wiring layers 501 and 502 adjacent in the direction of the axis AX to each other. The first and second outer coil wiring layers 501 and 502 are disposed on the insulating layers 11. The first via wiring layer 601 is disposed on the insulating layer 11. Although the present embodiment includes two coil wiring layers, three or more coil wiring layers may be included. Although the coil wiring layers have less than one turn, they may have one or more turns.

The first and second coil wiring layers 501 and 502 are wound along the planes, and form a helix while being electrically connected in series to each other. The coil wiring layers are wound along the XZ plane (main surfaces of the insulating layers 11) perpendicular to the direction of the axis AX (Y direction). The coil wiring layers 501 and 502 have a uniform width through their length.

The first via wiring layer 601 extends through the insulating layers 11 in a thickness direction (Y direction). The coil wiring layers adjacent to each other in the lamination direction are electrically connected in series to each other with the via wiring layer interposed therebetween. Thus, the first and second coil wiring layers 501 and 502 form a helix of the coil 20 while being electrically connected in series to each other with the first via wiring layer 601 interposed therebetween.

More specifically, the first coil wiring layer 501 and the second coil wiring layer 502 are laminated in order in the Y direction. The end portion of the first coil wiring layer 501 is connected to the first outer electrode conductor layers 33 of the first outer electrode 30. The end portion of the second coil wiring layer 502 is connected to the second outer electrode conductor layers 43 of the second outer electrode 40.

The first via wiring layer 601 is located between the first coil wiring layer 501 and the second coil wiring layer 502 to connect an end portion of the first coil wiring layer 501 and an end portion of the second coil wiring layer 502 to each other.

When viewed in the direction of the axis AX, the first via wiring layer 601 is a longitudinal via wiring layer 601 extending in the helical direction of the coil 20. The longitudinal via wiring layer 601 has a uniform width through its length. In the above embodiment, compared to a case where the first via wiring layer 601 is circular, the contact area between the first and second coil wiring layers 501 and 502 and the first via wiring layer 601 can be increased, and the direct current resistance of the coil 20 can be reduced. During manufacturing of the inductor component 1, regardless of when the first and second coil wiring layers 501 and 502 and the longitudinal via wiring layer 601 are laminated while being misaligned, the first and second coil wiring layers 501 and 502 and the longitudinal via wiring layer 601 are highly likely in contact with each other since the longitudinal via wiring layer 601 has a large area facing the first and second coil wiring layers 501 and 502. The present embodiment can thus reduce the possibility of the faulty electrical continuity between the first and second coil wiring layers 501 and 502 and the longitudinal via wiring layer 601. The present embodiment can also reduce disconnection of the longitudinal via wiring layer 601.

The present embodiment includes one via wiring layer, but may include multiple via wiring layers. When multiple via wiring layers are included, all the via wiring layers may be longitudinal via wiring layers. When multiple via wiring layers are included, at least one via wiring layer may be a longitudinal via wiring layer, and the other via wiring layers may be a circular (or quadrangular) via wiring layer when viewed in the direction of the axis AX. The end portion of the coil wiring layer connected to the circular via wiring layer forms a circular pad when viewed in the direction of the axis, and the diameter of the circular pad is greater than a line width of the coil wiring layer at an intermediate portion.

The wound portion 20a has an outer peripheral surface 20e and an inner peripheral surface 20d. When viewed in the direction of the axis AX, a first shortest distance 71 between the outer peripheral surface 20e of the wound portion 20a and the first outer electrode 30 is greater than a second shortest distance 72 between the outer peripheral surface 20e and the top surface 18. When the first shortest distance 71 is greater than the second shortest distance 72, the first outer electrode 30 and the coil 20 can be spaced a distance from each other. When the first outer electrode 30 and the coil 20 are spaced a distance from each other, the internal stress caused between the first outer electrode 30 and the coil 20 during firing is reduced. This structure can thus reduce occurrences of structural defects such as detachment in the first and second coil wiring layers 501 and 502 or the first via wiring layer 601. When the second shortest distance 72 is reduced, the coil 20 is located closer to the top surface 18 to be spaced apart from the first outer electrode 30. Thus, the stress from the first outer electrode 30 exerted on the inductor component 1 is reduced. When the first shortest distance 71 is small, the coil 20 is more likely to receive bending stress, thermal stress, or mounting impact stress from the mount board when being mounted on the mount board. In contrast, when the first shortest distance 71 is greater than the second shortest distance 72, the coil 20 is less likely to receive stress, and the load of stress on the coil 20 is reduced. When the second shortest distance 72 is reduced and the shortest distance between the bottom surface 17 and the outer peripheral surface 20e does not change, the outer diameter of the coil 20 is increased. In this case, the inductance value (L value) increases. With the similar operation effects, the first shortest distance between the outer peripheral surface 20e and the second bottom surface portion 42 of the second outer electrode 40 is greater than the second shortest distance between the outer peripheral surface 20e and the top surface 18. The outer peripheral surface 20e is an outermost outer peripheral surface of the wound portion 20a at a helically wound portion where the portions of the coil 20 overlap each other when viewed in the direction parallel to the axis AX. More specifically, the first shortest distance 71 is a distance between the first outer electrode 30 and the outer peripheral surface of the coil wiring layer, in a portion forming the wound portion 20a of each coil wiring layer, spaced a shortest distance from the first outer electrode 30. The second shortest distance 72 is a distance between the top surface 18 and the outer peripheral surface of the coil wiring layer, in a portion forming the wound portion 20a of each coil wiring layer, spaced a shortest distance from the top surface 18.

The first shortest distance 71 is the shortest distance between the outer peripheral surface 20e and the first outer electrode 30. The second shortest distance 72 is the shortest distance between the outer peripheral surface 20e and the top surface 18. In FIG. 2, the first shortest distance 71 is a distance between the outer peripheral surface 20e and the first bottom surface portion 32 of the first outer electrode 30, but may be a distance between the outer peripheral surface 20e and the second bottom surface portion 42 of the second outer electrode 40. The first shortest distance 71 may be a distance between the outer peripheral surface 20e and the first end surface portion 31 of the first outer electrode 30, or may be a distance between the outer peripheral surface 20e and the second end surface portion 41 of the second outer electrode 40.

Preferably, the first shortest distance 71 is greater than or equal to 15 μm, and the second shortest distance 72 is greater than or equal to 14 μm. For example, the first shortest distance 71 is greater than or equal to 17 μm, and the second shortest distance 72 is greater than or equal to 16.5 μm. When the first and second shortest distances 71 and 72 have the above values, the insulating layer between the first outer electrode 30 and the outer peripheral surface 20e of the wound portion 20a and the insulating layer between the outer peripheral surface 20e and the top surface 18 of the body 10 increase their thickness and strength. This structure can thus reduce occurrences of cracks during mounting. The upper limit of the first shortest distance is not limited to a particular value, but is smaller than or equal to, for example, 51 μm. When the upper limit of the first shortest distance exceeds 51 μm, the inductance is reduced. The upper limit of the second shortest distance is not limited to a particular value, but is smaller than or equal to, for example, 50 μm. When the upper limit of the second shortest distance exceeds 50 μm, the inductance is reduced.

Preferably, the first shortest distance 71 is greater than or equal to 5% of the dimension of the body 10 in the length direction (hereafter referred to as a length dimension L) in which the first end surface 15 and the second end surface 16 face each other, when viewed in the direction of the axis AX. The second shortest distance 72 is greater than or equal to 6% of the dimension of the body 10 in the height direction (hereafter referred to as a height dimension T) in which the top surface 18 and the bottom surface 17 face each other. When the first shortest distance 71 and the second shortest distance 72 are within the above range, the insulating layer between the first outer electrode 30 and the outer peripheral surface 20e of the wound portion 20a and the insulating layer between the top surface 18 of the body 10 and the outer peripheral surface 20e increase their thickness and strength. This structure can thus reduce occurrences of cracks during mounting. For example, in the inductor component 1 with the body 10 having a length dimension L of 263 μm and a height dimension T of 213 μm, the first shortest distance 71 is 15 μm, the second shortest distance 72 is 14 μm, a ratio of the first shortest distance 71 to the length dimension L is 5.7%, and a ratio of the second shortest distance 72 to the height dimension T is 6.6%. In addition, for example, in the inductor component 1 with the body 10 having a length dimension L of 250 μm and a height dimension T of 200 μm, the first shortest distance 71 is 15 μm, the second shortest distance 72 is 14 μm, a ratio of the first shortest distance 71 to the length dimension L is 6.0%, and a ratio of the second shortest distance 72 to the height dimension T is 7.0%. Similar operation effects are exerted on the thickness of the insulating layer between the second outer electrode 40 and the outer peripheral surface 20e and the thickness of the insulating layer between the top surface 18 of the body 10 and the outer peripheral surface 20e.

The length dimension L of the body 10 is a maximum dimension of the body 10 in the length direction when viewed in the direction of the axis AX. The height dimension T is a maximum dimension of the body 10 in the height direction when viewed in the direction of the axis AX.

The first shortest distance 71 may be smaller than or equal to 21% of the length dimension L. When the first shortest distance 71 exceeds 21%, the inductance is reduced. The second shortest distance 72 may be smaller than or equal to 26% of the height dimension T. When the second shortest distance 72 exceeds 26%, the inductance is reduced. For example, when the first shortest distance 71 is 51 μm, and the length dimension L is 250 μm, the ratio of the first shortest distance 71 to the length dimension L is 20.4%. When the second shortest distance 72 is 50 μm and the height dimension T is 250 μm, the ratio of the second shortest distance 72 to the height dimension T is 25%.

Preferably, a ratio T1/L1, or a ratio of a second inner diameter T1 of the wound portion 20a in the height direction (in other words, the height direction in which the bottom surface 17 and the top surface 18 face each other) to a first inner diameter L1 of the wound portion 20a in the length direction (in other words, the length direction in which the first end surface 15 and the second end surface 16 face each other) when viewed in the direction of the axis AX is greater than a ratio T/L, or a ratio of the height dimension T to the length dimension L. For example, in the inductor component 1 with the body 10 having a length L of 263 μm and a height T of 213 μm, the first inner diameter L1 is 94 μm, and the second inner diameter T1 is 109 μm. The ratio of the height T to the width L is 0.81, and the ratio of the second inner diameter T1 to the first inner diameter L1 is 1.16. Thus, the ratio T1/L1 is greater than the ratio T/L.

The inner diameter of the wound portion 20a is a diameter inside the coil 20 when viewed in the direction of the axis AX. When the coil 20 is wound to have one or more turns in a plane perpendicular to the axis AX, the innermost diameter of the coil 20 is referred to as the inner diameter of the wound portion 20a when viewed in the direction of the axis AX. The first inner diameter L1 is the largest inner diameter of the wound portion 20a in the length direction when viewed in the direction of the axis AX. The second inner diameter T1 is the largest inner diameter of the wound portion 20a in the height direction when viewed in the direction of the axis AX. The first inner diameter L1 may be a length passing the center of gravity (axis) of the inner diameter surrounded by the inner peripheral surface 20d and parallel to the direction (L direction) extending from the first end surface 15 to the second end surface 16. The second inner diameter T1 may be a length passing the center of gravity (axis) of the inner diameter surrounded by the inner peripheral surface 20d and parallel to the direction (T direction) extending from the bottom surface 17 to the top surface 18.

With the above structure, the first outer electrode 30 and the outer peripheral surface 20e are spaced further from each other. When they are spaced further from each other, the occurrence of stray capacitance between the first outer electrode 30 and the coil 20 can be reduced. When the second inner diameter T1 is increased, the area of the inner diameter can be increased, and the Q value can be increased. When the first outer electrode 30 includes the first end surface portion 31 and the first bottom surface portion 32, a third shortest distance 73 between the first end surface portion 31 and the outer peripheral surface 20e of the wound portion 20a can be increased. The increase of the distance can further reduce stray capacitance between the first end surface portion 31 and the outer peripheral surface 20e of the wound portion 20a. The second outer electrode 40 also has similar operation effects.

The third shortest distance 73 is a distance between the outer peripheral surface 20e and the first end surface portion 31 from the outer peripheral surface 20e to the first end surface portion 31 when viewed in the direction of the axis AX.

Preferably, the ratio of the second inner diameter T1 to the first inner diameter L1 (that is, 100×T1/L1) is greater than or equal to 110%. Although not limited to a particular value, the upper limit of the ratio is, for example, smaller than or equal to 125%. For example, in the inductor component 1 with the first inner diameter L1 of 94 μm and the second inner diameter T1 of 109 μm, the ratio of the second inner diameter T1 to the first inner diameter L1 is 116%. The inductor component 1 having the above ratio can increase the second inner diameter T1, the area of the inner diameter, and the Q value. In addition, the inductor component 1 with the first inner diameter L1 reduced can increase the third shortest distance 73 between the first end surface portion 31 of the first outer electrode 30 and the outer peripheral surface 20e of the wound portion 20a. Thus, the inductor component 1 can further reduce stray capacitance between the first end surface portion 31 of the first outer electrode 30 and the outer peripheral surface 20e of the wound portion 20a.

### Manufacturing Method

Subsequently, a method for manufacturing the inductor component 1 is described.

As illustrated in FIG. 3, from the upper left to the lower right in the drawing, the first and second coil wiring layers 501 and 502 and the first via wiring layer 601 are alternately laminated with the insulating layers 11 interposed therebetween to manufacture the inductor component 1. The first and second coil wiring layers 501 and 502 are disposed on the insulating layers 11 by, for example, screen printing. The first via wiring layers 601 are formed by, for example, screen printing at openings formed in the insulating layers 11 by, for example, photolithography or laser printing.

### Second Embodiment

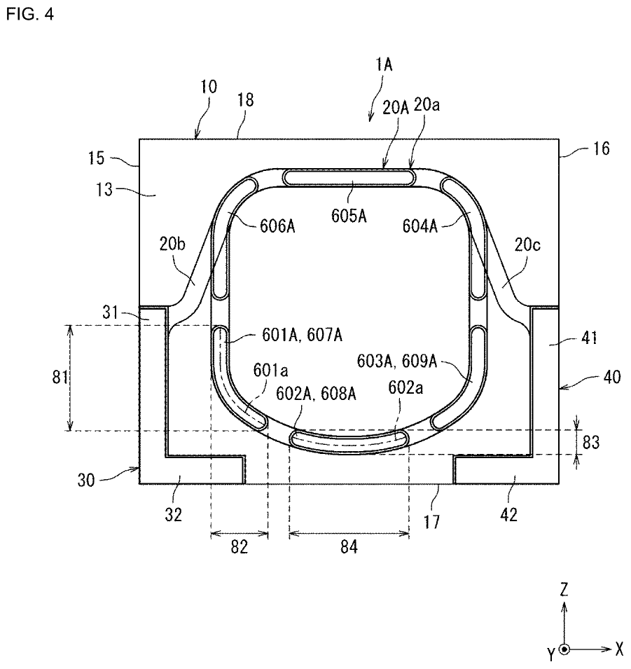

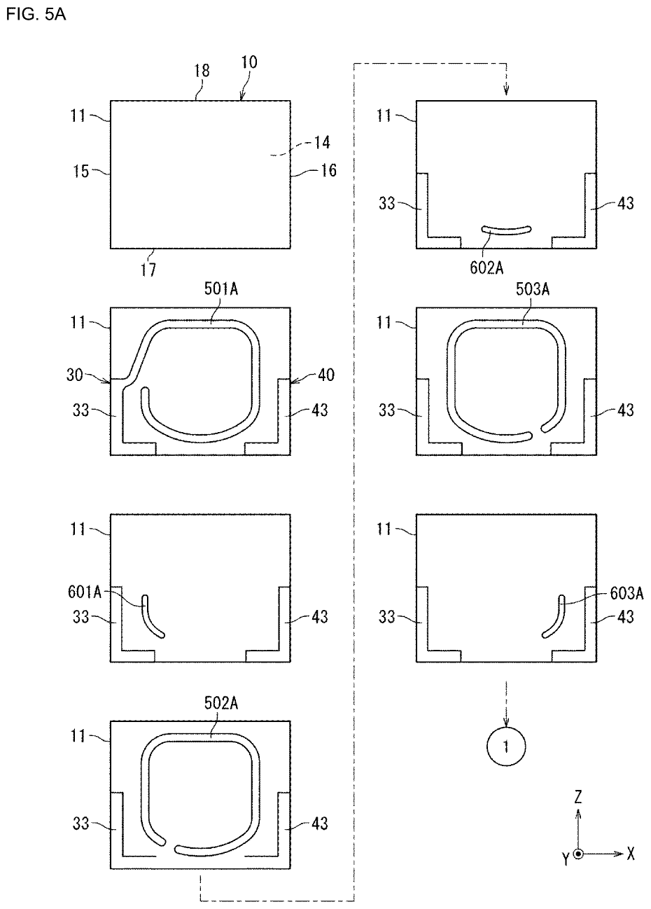

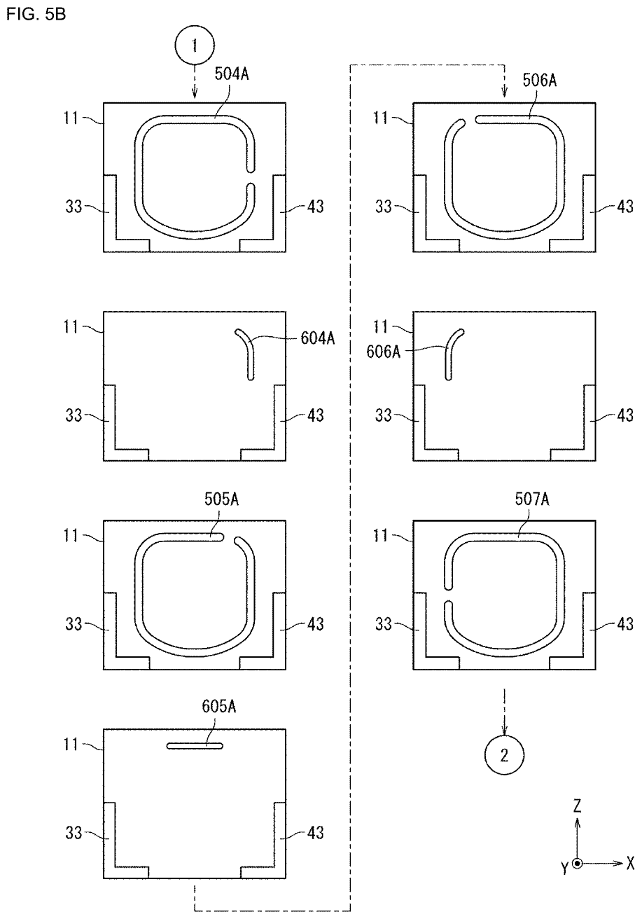

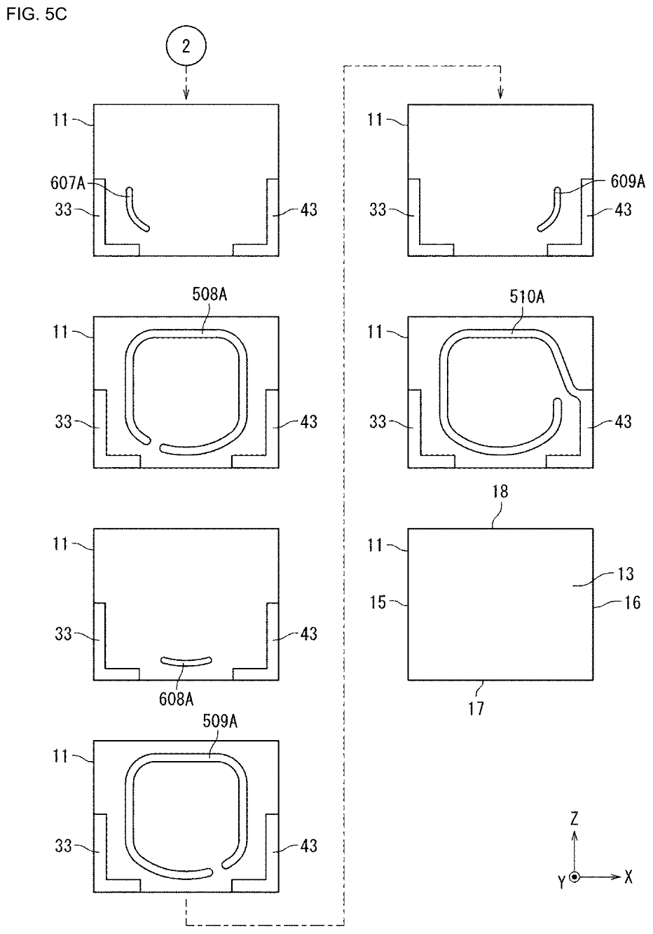

FIG. 4 is a perspective front view of an inductor component according to a second embodiment when viewed in the direction from the first side surface of the inductor component. FIG. 5A, FIG. 5B, and FIG. 5C are exploded plan views of the inductor component. The second embodiment differs from the first embodiment in that the numbers and the positions of the coil wiring layers and the via wiring layers. These different components are described below. Other components are the same as those in the first embodiment, and are denoted with the same reference signs as those in the first embodiment without being described.

As illustrated in FIG. 4, FIG. 5A, FIG. 5B, and FIG. 5C, in an inductor component 1A according to the second embodiment, a coil 20A includes multiple coil wiring layers 501A to 510A laminated along the axis AX, and multiple via wiring layers 601A to 609A each located between the coil wiring layers adjacent to each other in the direction of the axis AX to connect the coil wiring layers adjacent to each other in the direction of the axis AX. The multiple coil wiring layers 501A to 510A are each disposed on the corresponding one of the insulating layers 11, and the via wiring layers 601A to 609A are each disposed on the corresponding one of the insulating layers 11.

The multiple coil wiring layers 501A to 510A form a helix while being wound along the plane and electrically connected to each other in series. The multiple coil wiring layers 501A to 510A are formed by being wound along the XZ plane (the main surfaces of the insulating layers 11) perpendicular to the direction of the axis AX (Y direction). All the coil wiring layers 501A to 510A have a uniform width through their length.

The multiple via wiring layers 601A to 609A extend through the insulating layers 11 in the thickness direction (Y direction). When viewed in the direction of the axis AX, the multiple via wiring layers 601A to 609A extend in the helical direction of the coil 20A. The coil wiring layers adjacent to each other in the lamination direction are electrically connected in series to each other with the via wiring layers interposed therebetween. All the via wiring layers 601A to 609A are longitudinal via wiring layers.

More specifically, a first coil wiring layer 501A, a second coil wiring layer 502A, a third coil wiring layer 503A, a fourth coil wiring layer 504A, a fifth coil wiring layer 505A, a sixth coil wiring layer 506A, a seventh coil wiring layer 507A, an eighth coil wiring layer 508A, a ninth coil wiring layer 509A, and a tenth coil wiring layer 510A are laminated in order in the Y direction. The end portion of the first coil wiring layer 501A is connected to the first outer electrode conductor layers 33 of the first outer electrode 30. The end portion of the tenth coil wiring layer 510A is connected to the second outer electrode conductor layers 43 of the second outer electrode 40.

A first via wiring layer 601A, a second via wiring layer 602A, a third via wiring layer 603A, a fourth via wiring layer 604A, a fifth via wiring layer 605A, a sixth via wiring layer 606A, a seventh via wiring layer 607A, an eighth via wiring layer 608A, and a ninth via wiring layer 609A are laminated in order in the Y direction. The first via wiring layer 601A and the seventh via wiring layer 607A overlap each other when viewed in the direction of the axis AX. The second via wiring layer 602A and the eighth via wiring layer 608A overlap each other when viewed in the direction of the axis AX. The third via wiring layer 603A and the ninth via wiring layer 609A overlap each other when viewed in the direction of the axis AX. All the via wiring layers 601A to 609A have a uniform width through their length. Instead, a subset of the via wiring layers may have a width that varies through its length.

The first via wiring layer 601A is located between the first coil wiring layer 501A and the second coil wiring layer 502A to connect an end portion of the first coil wiring layer 501A and an end portion of the second coil wiring layer 502A to each other. The second via wiring layer 602A is located between the second coil wiring layer 502A and the third coil wiring layer 503A to connect an end portion of the second coil wiring layer 502A and an end portion of the third coil wiring layer 503A to each other. The third via wiring layer 603A is located between the third coil wiring layer 503A and the fourth coil wiring layer 504A to connect an end portion of the third coil wiring layer 503A and an end portion of the fourth coil wiring layer 504A to each other. The fourth via wiring layer 604A is located between the fourth coil wiring layer 504A and the fifth coil wiring layer 505A to connect an end portion of the fourth coil wiring layer 504A and an end portion of the fifth coil wiring layer 505A to each other. The fifth via wiring layer 605A is located between the fifth coil wiring layer 505A and the sixth coil wiring layer 506A to connect an end portion of the fifth coil wiring layer 505A and an end portion of the sixth coil wiring layer 506A to each other.

The sixth via wiring layer 606A is located between the sixth coil wiring layer 506A and the seventh coil wiring layer 507A to connect an end portion of the sixth coil wiring layer 506A and an end portion of the seventh coil wiring layer 507A to each other. The seventh via wiring layer 607A is located between the seventh coil wiring layer 507A and the eighth coil wiring layer 508A to connect an end portion of the seventh coil wiring layer 507A and an end portion of the eighth coil wiring layer 508A to each other. The eighth via wiring layer 608A is located between the eighth coil wiring layer 508A and the ninth coil wiring layer 509A to connect an end portion of the eighth coil wiring layer 508A and an end portion of the ninth coil wiring layer 509A to each other. The ninth via wiring layer 609A is located between the ninth coil wiring layer 509A and the tenth coil wiring layer 510A to connect an end portion of the ninth coil wiring layer 509A and an end portion of the tenth coil wiring layer 510A to each other.

The via wiring layers include a vertically long via wiring layer and a horizontally long via wiring layer. In the vertically long via wiring layer, a height 81 of a T component in a direction from the bottom surface 17 to the top surface 18 is greater than a length 82 of an L component in a direction from the first end surface 15 to the second end surface 16. In the horizontally long via wiring layer, a length 84 of an L component in a direction from the first end surface 15 to the second end surface 16 is greater than a height 83 of a T component in a direction from the bottom surface 17 to the top surface 18. The via wiring layers may include only vertically long via wiring layers or only horizontally long via wiring layers.

The height of the T component in a direction from the bottom surface 17 to the top surface 18 of the body 10 is a height of the via wiring layer when it is projected on the first end surface 15 of the body 10 in the direction parallel to the X direction. The length of the L component in a direction from the first end surface 15 to the second end surface 16 of the body 10 is a length of the via wiring layer when it is projected on the bottom surface 17 of the body 10 in the direction parallel to the Z direction.

More specifically, the first via wiring layer 601A is a first vertically long via wiring layer 601A. The third via wiring layer 603A is a second vertically long via wiring layer 603A. The fourth via wiring layer 604A is a third vertically long via wiring layer 604A. The sixth via wiring layer 606A is a fourth vertically long via wiring layer 606A. The seventh via wiring layer 607A is a fifth vertically long via wiring layer 607A. The ninth via wiring layer 609A is a sixth vertically long via wiring layer 609A.

More specifically, the second via wiring layer 602A is a first horizontally long via wiring layer 602A. The fifth via wiring layer 605A is a second horizontally long via wiring layer 605A. The eighth via wiring layer 608A is a third horizontally long via wiring layer 608A.

The via wiring layers may include a via wiring layer in which the length 84 of the L component in a direction from the first end surface 15 to the second end surface 16 and the height 83 of the T component in a direction from the bottom surface 17 to the top surface 18 are the same. The via wiring layer in this case is neither a vertically long via wiring layer nor a horizontally long via wiring layer.

The via wiring layers include vertically long via wiring layers. More specifically, the via wiring layers include first to sixth vertically long via wiring layers 601A, 603A, 604A, 606A, 607A, and 609A. When the via wiring layers include longitudinal via wiring layers such as the first to sixth vertically long via wiring layers 601A, 603A, 604A, 606A, 607A, and 609A, the contact areas between the longitudinal via wiring layers and the coil wiring layer increase to improve the connectability between these layers. In addition, when the via wiring layers include the first to sixth vertically long via wiring layers 601A, 603A, 604A, 606A, 607A, and 609A, stray capacitance that occurs between the vertically long via wiring layers and the first bottom surface portion 32 and the second bottom surface portion 42 can be reduced.

Preferably, the ratio of the wiring length of the first vertically long via wiring layer 601A to the width of the first vertically long via wiring layer 601A is greater than or equal to 130% and smaller than or equal to 2500% (i.e., from 130% to 2500%). When the vertically long via wiring layer exceeds 2500%, the inductance is reduced. The wiring length of the first vertically long via wiring layer 601A is a length of a center line 601a extending in the direction in which the first vertically long via wiring layer 601A extends. The width of the first vertically long via wiring 601A is the maximum width in the direction perpendicular to the center line 601a. The second to sixth vertically long via wiring layers 603A, 604A, 606A, 607A, and 609A also have similar operation effects as those of the first vertically long via wiring layer 601A. At least one of the vertically long via wiring layers may have the above ratio.

The via wiring layers include horizontally long via wiring layers. More specifically, the via wiring layers include first to third horizontally long via wiring layers 602A, 605A, and 608A. When the via wiring layers include longitudinal via wiring layers such as the first to third horizontally long via wiring layers 602A, 605A, and 608A, the contact areas between the longitudinal via wiring layers and the coil wiring layers increase to improve the connectability between these layers. In addition, when the via wiring layers include the first to third horizontally long via wiring layers 602A, 605A, and 608A, stray capacitance that occurs between the horizontally long via wiring layers and the first end surface portion 31 and the second end surface portion 41 can be reduced.

Preferably, the ratio of the wiring length of the first horizontally long via wiring layer 602A to the width of the first horizontally long via wiring layer 602A is greater than or equal to 130%. Although not limited to a particular value, the upper limit of the ratio is smaller than or equal to 2200%. When the horizontally long via wiring layer exceeds 2200%, the inductance is reduced.

The wiring length of the first horizontally long via wiring layer 602A is a length of a center line 602a extending in the direction in which the first horizontally long via wiring layer 602A extends. The width of the first horizontally long via wiring layer 602A is the maximum width in the direction perpendicular to the center line 602a. The second and third horizontally long via wiring layers 605A and 608A also have the same operation effects as the first horizontally long via wiring layer 602A. At least one of the horizontally long via wiring layers may have the above ratio.

In an aspect, when the via wiring layers include a vertically long via wiring layer and a horizontally long via wiring layer, the total number of vertically long via wiring layers is greater than the total number of horizontally long via wiring layers. In the above structure, the coil 20 is allowed to be a vertically long coil, and the coil 20 can be wound with an improved winding efficiency while the contact area between the via wiring layers and the coil wiring layers is increased. The above structure can thus improve the connectability between the via wiring layers and the coil wiring layers and achieve a high L value.

In an aspect, when the via wiring layers include vertically long via wiring layers and horizontally long via wiring layers, the total number of horizontally long via wiring layers is greater than the total number of vertically long via wiring layers. In the above structure, the coil is allowed to be a horizontally long coil, and the coil 20 can be wound with an improved winding efficiency while the contact area between the via wiring layers and the coil wiring layers is increased. The above structure can thus improve the connectability between the via wiring layers and the coil wiring layers and achieve a high L value.

Instead of the above embodiments, the present disclosure may be changed in design within the scope not departing from the gist of the disclosure. For example, the features of the first and second embodiments may be combined in various manners. Instead, the coil wiring layers may be increased or decreased, or the via wiring layers may be increased or decreased.

The present disclosure includes the following aspects.

<1> An inductor component, comprising a body; a coil disposed in the body and helically wound about an axis; and a first outer electrode and a second outer electrode disposed at the body and electrically connected to the coil. The body has a first end surface and a second end surface opposite to each other, a first side surface and a second side surface opposite to each other, a bottom surface that connects the first end surface and the second end surface to each other and connects the first side surface and the second side surface to each other, and a top surface opposite to the bottom surface. The first outer electrode and the second outer electrode are disposed at least on the bottom surface. The axis is parallel to the bottom surface and crosses the first side surface and the second side surface. The coil includes a wound portion helically wound about the axis. Also, when viewed in a direction of the axis, a first shortest distance between an outer peripheral surface of the wound portion and the first outer electrode is greater than a second shortest distance between the outer peripheral surface and the top surface.

<2> The inductor component according to <1>, wherein the first shortest distance is greater than or equal to 15 μm, and the second shortest distance is greater than or equal to 14 μm.

<3> The inductor component according to <1> or <2>, wherein the first shortest distance is greater than or equal to 5% of a dimension of the body in a length direction in which the first end surface and the second end surface face each other. Also, the second shortest distance is greater than or equal to 6% of a dimension of the body in a height direction in which the bottom surface and the top surface face each other.

<4> The inductor component according to any one of <1> to <3>, wherein a ratio T1/L1, or a ratio of a second inner diameter T1 of the wound portion in a height direction in which the bottom surface and the top surface face each other to a first inner diameter L1 of the wound portion in a length direction in which the first end surface and the second end surface face each other when viewed in the direction of the axis is greater than a ratio of a dimension of the body in the height direction to a dimension of the body in the length direction.

<5> The inductor component according to any one of <1> to <4>, wherein a ratio of a second inner diameter T1 of the wound portion in a height direction in which the bottom surface and the top surface of the body face each other to a first inner diameter L1 of the wound portion in a length direction in which the first end surface and the second end surface of the body face each other is greater than or equal to 110%.

<6> The inductor component according to any one of <1> to <5>, wherein the coil includes coil wiring layers laminated along the axis, and a via wiring layer located between the coil wiring layers adjacent to each other in the direction of the axis to connect the coil wiring layers adjacent to each other in the direction of the axis. The via wiring layer includes a vertically long via wiring layer. Also, in the vertically long via wiring layer, a height of a T component in a direction from the bottom surface to the top surface of the body is greater than a length of an L component in a direction from the first end surface to the second end surface.

<7>The inductor component according to <6>, wherein a ratio of a wiring length of the vertically long via wiring layer to a width of the vertically long via wiring layer is greater than or equal to 130% and smaller than or equal to 2500% (i.e., from 130% to 2500%).

<8> The inductor component according to any one of <1> to <7>, wherein the coil includes coil wiring layers laminated along the axis, and a via wiring layer located between the coil wiring layers adjacent to the axis to connect the coil wiring layers adjacent to each other in the direction of the axis. The via wiring layer includes a horizontally long via wiring layer. Also, in the horizontally long via wiring layer, a length of an L component in a direction from the first end surface to the second end surface is greater than a height of a T component in a direction from the bottom surface to the top surface.

<9> The inductor component according to <8>, wherein a ratio of a wiring length of the horizontally long via wiring layer to a width of the horizontally long via wiring layer is greater than or equal to 130% and smaller than or equal to 2200% (i.e., from 130% to 2200%).

What is claimed is:

1. An inductor component, comprising:
a body having a first end surface and a second end surface opposite to each other, a first side surface and a second side surface opposite to each other, a bottom surface that connects the first end surface and the second end surface to each other and connects the first side surface and the second side surface to each other, and a top surface opposite to the bottom surface;
a coil in the body and helically wound about an axis that is parallel to the bottom surface and intersects the first side surface and the second side surface, and the coil includes a wound portion helically wound about the axis; and
a first outer electrode and a second outer electrode at the body and electrically connected to the coil, the first outer electrode and the second outer electrode being at least on the bottom surface,
wherein when viewed in a direction of the axis, a first shortest distance between an outer peripheral surface of the wound portion and the first outer electrode is greater than a second shortest distance between the outer peripheral surface of the wound portion and the top surface.

2. The inductor component according to claim 1, wherein
the first shortest distance is greater than or equal to 15 μm, and
the second shortest distance is greater than or equal to 14 μm.

3. The inductor component according to claim 1, wherein
the first shortest distance is greater than or equal to 5% of a dimension of the body in a length direction in which the first end surface and the second end surface face each other, and
the second shortest distance is greater than or equal to 6% of a dimension of the body in a height direction in which the bottom surface and the top surface face each other.

4. The inductor component according to claim 1, wherein
a ratio T1/L1, or a ratio of a second inner diameter T1 of the wound portion in a height direction in which the bottom surface and the top surface face each other to a first inner diameter L1 of the wound portion in a length direction in which the first end surface and the second end surface face each other when viewed in the direction of the axis is greater than a ratio of a dimension of the body in the height direction to a dimension of the body in the length direction.

5. The inductor component according to claim 1, wherein
a ratio T1/L1, or a ratio of a second inner diameter T1 of the wound portion in a height direction in which the bottom surface and the top surface of the body face each other to a first inner diameter L1 of the wound portion in a length direction in which the first end surface and the second end surface of the body face each other is greater than or equal to 110%.

6. The inductor component according to claim 1, wherein
the coil includes
coil wiring layers laminated along the axis, and
a via wiring layer located between the coil wiring layers adjacent to each other in the direction of the axis to connect the coil wiring layers adjacent to each other in the direction of the axis,
wherein
the via wiring layer includes a vertically long via wiring layer, and
in the vertically long via wiring layer, a height of a T component in a direction from the bottom surface to the top surface of the body is greater than a length of an L component in a direction from the first end surface to the second end surface.

7. The inductor component according to claim 6, wherein
a ratio of a wiring length of the vertically long via wiring layer to a width of the vertically long via wiring layer is from 130% to 2500%.

8. The inductor component according to claim 1, wherein
the coil includes
coil wiring layers laminated along the axis, and
a via wiring layer located between the coil wiring layers adjacent to each other in the direction of the axis to connect the coil wiring layers adjacent to each other in the direction of the axis,
wherein
the via wiring layer includes a horizontally long via wiring layer, and
in the horizontally long via wiring layer, a length of an L component in a direction from the first end surface to the second end surface is greater than a height of a T component in a direction from the bottom surface to the top surface.

9. The inductor component according to claim 8, wherein
a ratio of a wiring length of the horizontally long via wiring layer to a width of the horizontally long via wiring layer is from 130% to 2200%.

10. The inductor component according to claim 2, wherein
the first shortest distance is greater than or equal to 5% of a dimension of the body in a length direction in which the first end surface and the second end surface face each other, and
the second shortest distance is greater than or equal to 6% of a dimension of the body in a height direction in which the bottom surface and the top surface face each other.

11. The inductor component according to claim 2, wherein
a ratio T1/L1, or a ratio of a second inner diameter T1 of the wound portion in a height direction in which the bottom surface and the top surface face each other to a first inner diameter L1 of the wound portion in a length direction in which the first end surface and the second end surface face each other when viewed in the direction of the axis is greater than a ratio of a dimension of the body in the height direction to a dimension of the body in the length direction.

12. The inductor component according to claim 2, wherein
a ratio T1/L1, or a ratio of a second inner diameter T1 of the wound portion in a height direction in which the bottom surface and the top surface of the body face each other to a first inner diameter L1 of the wound portion in a length direction in which the first end surface and the second end surface of the body face each other is greater than or equal to 110%.

13. The inductor component according to claim 2, wherein
the coil includes
coil wiring layers laminated along the axis, and
a via wiring layer located between the coil wiring layers adjacent to each other in the direction of the axis to connect the coil wiring layers adjacent to each other in the direction of the axis,
wherein
the via wiring layer includes a vertically long via wiring layer, and
in the vertically long via wiring layer, a height of a T component in a direction from the bottom surface to the top surface of the body is greater than a length of an L component in a direction from the first end surface to the second end surface.

14. The inductor component according to claim 13, wherein
a ratio of a wiring length of the vertically long via wiring layer to a width of the vertically long via wiring layer is from 130% to 2500%.

15. The inductor component according to claim 2, wherein
the coil includes
coil wiring layers laminated along the axis, and
a via wiring layer located between the coil wiring layers adjacent to each other in the direction of the axis to connect the coil wiring layers adjacent to each other in the direction of the axis,
wherein
the via wiring layer includes a horizontally long via wiring layer, and
in the horizontally long via wiring layer, a length of an L component in a direction from the first end surface to the second end surface is greater than a height of a T component in a direction from the bottom surface to the top surface.

16. The inductor component according to claim 15, wherein
a ratio of a wiring length of the horizontally long via wiring layer to a width of the horizontally long via wiring layer is from 130% to 2200%.
